(19) United States
(12) Patent Application Publication
(10) Pub. No.: US 2004/0108306 A1
(43) Pub. Date: Jun. 10, 2004

(54) Laser heat treatment of crankshaft fillets

(76) Inventors: Michael Wiezbowski, Rochester Hills, MI (US); Xichen Sun, Windsor (CA)

Correspondence Address: Ralph E. Smith, DaimlerChrysler Intellectual Capital Corporation, 800 Chrysler Drive East, Auburn Hills, MI, 48326-2757, US

(21) Appl. No.: 10/310,784

(22) Filed: Dec. 6, 2002

(51) Int. Cl. B23K 26/00

(52) U.S. Cl. 219/121.85

(57) ABSTRACT

A diode laser is integrated into fillet heat treatment applications for producing crankshafts, thereby eliminating the need for the mechanical rolling process, polymer-based water quench process, straightening process, and the temper process for treating oil holes not treated by conventional processing, while increasing the strength of the manufactured part.

### BACKGROUND AND SUMMARY OF THE INVENTION

The invention relates to the manufacture of mechanical parts, and more particularly to the manufacture of automotive parts using laser heat treatment.

Automotive manufacturers, not unlike many manufacturers, seek to produce lighter, stronger products and parts to improve, among others things, fuel economy, durability, and ease and cost of manufacturing. Design requirements for lighter parts require an increase in the operational strength behavior of the material used in the lighter part. In the case of crankshafts, increased strength may be accomplished through mechanical methods, such as a mechanical rolling process where crankshaft fillets are rolled 360 degrees. The mechanical rolling process imparts residual compressive stresses to the fillet that are directly proportional to increases in material fatigue strength.

Another method of improving material strength is the employment of surface heat treatment using an induction heating process, which can impart a surface compressive stress. The induction heating process requires a large power supply to generate enough heat for the ductile iron (nodular) casting to transform into austenite which is then followed by rapid cooling to transform austenite to hardened martensite. The conversion to martensite provides a volume expansion that causes a surface compressive stress to form in the martensite layer which increases the loading and fatigue properties of the material. With current manufacturing processes the crankshaft strength cannot be increased any further. Consequently, engineers look to substitute more expensive materials such as S.A.E. 1050 or other micro-alloyed steels, which allow for higher loads.

Currently, automakers use the induction heating process to harden the bearings of a crankshaft while a mechanical rolling process is utilized to roll the fillets to improve compressive stresses. These processes are capital-intensive, time-intensive, lead to nonuniformities, and have a crack propensity in the oil lubrication holes that require a tempering process. Rolled fillets 10 and oil lubrication holes 12 are shown in FIG. 1.

The foregoing demonstrates that there is a need for an improved process for manufacturing parts which satisfies the need and avoids the drawbacks of the prior art. The invention employs laser and electron-beam technology for hardening mechanical parts using heat treatment. Laser technology is effective in this application for a variety of reasons. For example, the laser may be controlled to provide a uniform depth with a high intensity and focused beam. The controlled radiation permits a shallow penetration of heat that allows the surrounding material to act as a heat sink, which allows a mass quench of the fillet without the need for a polymer/water based quench. Furthermore, the present invention avoids heat in the oil lubrication holes and thereby eliminates the crack propensity and any need for a subsequent temper process. The lower level of heat that is transferred into the part equates to potential straightening benefits. Finally, the compressive stress induced by laser hardening fillets makes the mechanical rolling process unnecessary. The compressive stresses imparted by the process of the invention permit a designer to use a more cost effective material without compromising the performance requirements or fatigue properties of the manufactured part.

As stated above, the present invention provides substantial benefits as it eliminates the need for the current mechanical rolling process, the polymer-based water quench used in induction heating processes (as mass quenching is sufficient), any straightening process, and the temper process for treating oil holes not treated by conventional processing, while increasing the strength of the manufactured part.

The present invention also permits the manufacture of a smaller, stronger component using current materials of construction that will result in material savings and reduced weight thereby contributing to improved fuel economy.

Other objects, advantages and novel features of the present invention will become apparent from the following detailed description of the invention when considered in conjunction with the accompanying drawings.

### BRIEF DESCRIPTION OF THE DRAWINGS

FIG. 1 provides a view of a rolled fillet.

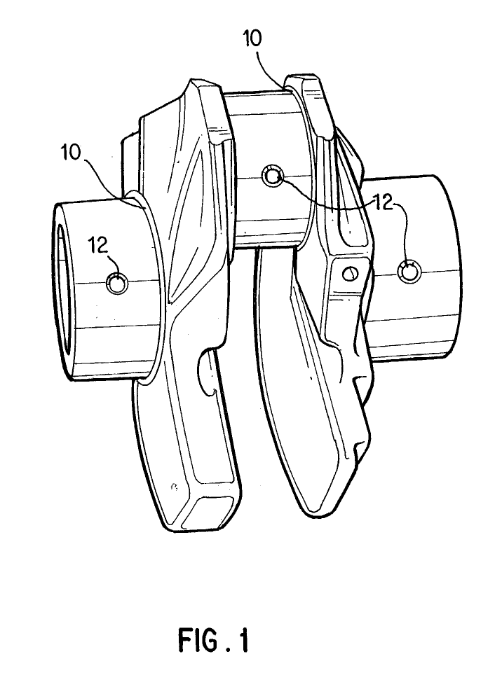

FIGS. 2A and 2B show hardened case profiles.

FIGS. 3A and 3B display microstructures.

### DETAILED DESCRIPTION OF THE DRAWINGS

In one aspect of the invention a diode laser is integrated into fillet heat treatment applications for producing crankshafts, thereby eliminating a number of traditional processing unit operations as discussed above.

In tests conducted in accordance with the invention, the results for which are included in the Table below, a diode laser rated at 50 kW output and a motorized rotary table were employed. The material used in the tests was typical production material, which is a ductile iron casting. Bearing sections were cut from a full size production part and heated one fillet at a time. Each bearing section was placed on the rotary table, which was coupled to a DC motor for rotation of the table and bearing section. As the part was rotated the laser was energized are directed toward the fillet. After a full revolution of the bearing fillet, the laser was turned off. Thereafter, each part was tested to measure its compressive strength using a well known, x-ray diffraction technique that measures atomic spacing.

As can be seen with reference to the Table, test conditions for Sample ID #9 provided the maximum compressive stresses (−96 ksi to −98 ksi). The conditions for this test are that the laser was operated at 63% of its maximum output, or approximately 31.5 kW, and the rotation speed of the part was 1 m/min. At these conditions, the heated depth or case depth into the part receiving the laser energy is 0.6 mm or 0.024 inches using, for example, a nital solution, which is described below. As can be understood from the Table, if the case depth of the laser energy penetration is insufficient, the compressive strength of the part suffers. On the other hand, if either the laser energy or the laser penetration into the part is too great, the part experiences low compressive strength and melting and possibly cracking. Therefore, identifying the appropriate amount of laser power and length of exposure, determined by rotation speed, is an important aspect of producing an optimum part. According to the test results, 0.6 mm of case depth with 31.5 kW and a 1 m/min rotation gave satisfactory results, however, case depths of 0.55 to 0.65 mm and 0.5 to 0.7 mm may provide suitable results when laser exposure is controlled to avoid surface damage of the material according to the principles of the invention. Of course, according to the invention there are numerous power/time combinations that could be used to obtain the required case depth and associated compressive strength results. For example, increasing laser power by 20% would permit a faster rotation speed by about 20% to obtain a suitable case depth. Alternatively, a slower rotation speed may be coupled with a lower laser power output to achieve the substantial results of the invention.

In one aspect of the invention, parts that are clean, being free of oil and burrs, may be manually or automatically loaded into a laser heat station where each part may be captured between center spindles. The center spindles may be designed to rotate each part during the laser heating process. Of course, the center spindles may be rotated at different speeds, according to the principles of the invention, which would cause the worked-upon part to rotate at various speeds and may require an associated modification of laser output energy.

In one preferred embodiment, the laser beam is energized and focused toward a manufactured part, e.g., the fillet area of a bearing. The energy from the laser creates localized heating of the fillet to an austenetic surface temperature of about 1600-1700° F.

An optical pyrometer may be used to measure the surface temperature of the worked-upon part and may be coupled to a 4-20 ma control signal that may be utilized to provide a closed-loop temperature control of the laser. The pyrometer may act as a quality control tool facilitating the application of laser power by assuring that the correct laser power density is applied to the surface of a part and avoiding an underheated or overheated surface condition. One example of a useful closed-loop temperature control is found in U.S. Pat. No. 6,084,224, the disclosure of which is incorporated by reference in its entirety.

A laser beam may direct energy to one or more fillets at a time as may be accomplished using a beam splitter and mirrors to direct the beam toward each fillet at the correct angle, which maximizes the heating efficiency of the fillet.

The diode laser may be mounted on a controllable x,y base that may be operated in such a manner to maintain a constant distance between the laser head and the fillet while the fillet is being rotated in order to facilitate uniform heating of the fillet. Fillets that are on the centerline of crankshaft, e.g., main bearings, are located such that they are at a fixed distance from a stationary laser beam during rotation of the fillet. Alternatively, fillets that are offset from the centerline of the crankshaft, e.g., pin bearings, may employ a controllable x,y mechanism to maintain a fixed heating distance between the laser and the fillet. The x,y positioning of the laser may also be accomplished by mounting the laser head onto an articulating robot in order to maintain a fixed distance between laser and fillet.

According to one aspect of the invention, each fillet is heated completely during one full 360-degree revolution. However, portions of the worked-upon part that experience a second heating caused by overlapping laser treatment do not demonstrate degradation of metallurgical performance.

In a preferred aspect, the heated fillet is self-quenched by the surrounding material mass, which is not subjected to elevated temperatures caused by laser treatment. This feature avoids the water quench that is required by current processes.

After the application of laser energy, the part may be manually or automatically indexed to the next treatment position. For example, the crankshaft is indexed to the next bearing position for laser heat treatment. After the treatment of the part is complete, the part may be placed in dunnage.

As shown below, Sample ID #9 had a compressive stress of −98 ksi as compared to a rolled production fillet using a current process that had a compressive stress of −43 ksi. Therefore, the laser heat-treated fillet had 2.3 times greater compressive stress, which translates to a direct increase in fatigue strength.

TABLE

| | | Rotation | Case | | |
|---|---|---|---|---|---|
| | Laser Power | speed | depth | Stress | |
| Sample ID | level (%) | (m/min) | (mm) | (ksi) | Remarks |
| Non-rolled | N/A | N/A | N/A | +19 | Fillet Area |
| Rolled | N/A | N/A | N/A | 43 | without undercut |
| Non-rolled | Unknown | 1.2 | 0 | 106 | from 5.2 L |
| Non-rolled | Unknown | 1.2 | 0.15 | −6 | crankshaft. |
| Non-rolled | Unknown | 1.2 | 0.20 | −7 | |
| Non-rolled | Unknown | 1.2 | 0.22 | −10 | |
| Non-rolled | Unknown | 1.2 | 0.25 | −21 | |
| Non-rolled | Unknown | 1.2 | 0.25 | −24 | |
| Non-rolled | Unknown | 1.2 | 0.25 | −28 | |
| Non-rolled | Unknown | 1.2 | 0.44 | −68 | |
| #4 | 68 | 1.2 | 0.6 | −30 | Incipient |
| #8 | 65 | 1.0 | 0.6 | −32 | melting |
| #9-1 | 63 | 1.0 | 0.6 | −98 | 0 degree |
| #9-2 | 63 | 1.0 | 0.6 | −98 | 120 degree |
| #9-3 | 63 | 1.0 | 0.6 | −96 | 240 degree |
| #13 | 72 | 1.2 | 0.66 | −20 | Melting and |
| | | | | | cracking |

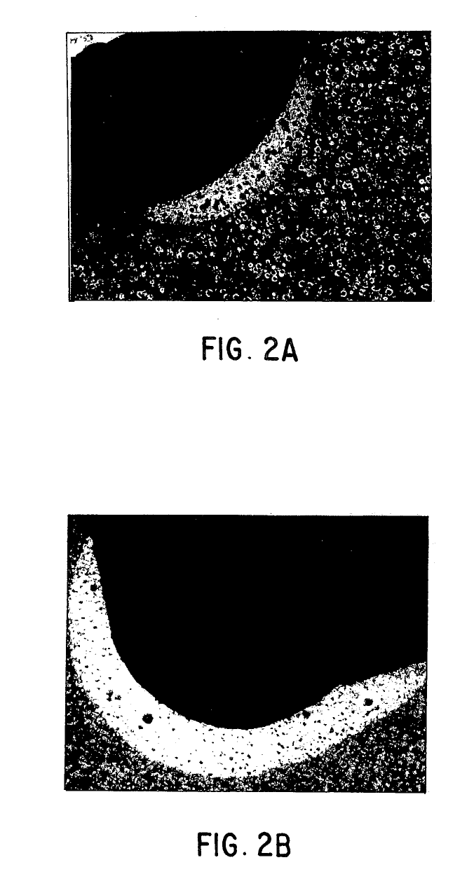

FIGS. 2A and 2B display hardened case profiles using the process of the invention. FIG. 2A shows one type of fillet in connection with a 5.2 L crankshaft that is referred to as a “radius fillet.” This fillet has a continuous smooth radius and is used when bearing clearance is not a problem. FIG. 2B shows a second type of fillet called an “undercut fillet” from a 2.4 L crankshaft. This fillet design is utilized when bearing clearance is an issue and a radius fillet, therefore, cannot be used. The undercut fillet design displays an undercut surface adjacent to the bearing surface. Both radius and undercut fillets may employ the process of the invention to achieve maximum strength by varying the laser power density and the exposure time period. As discussed above, underexposure to radiation may result in structural weakness and overexposure may lead to weakness and melting. Therefore, suitable parts may be manufactured by balancing the laser output and exposure period to achieve an effective case depth without too much laser power. As shown by Sample ID #9 above, the case depth of about 0.6 mm provides a good result.

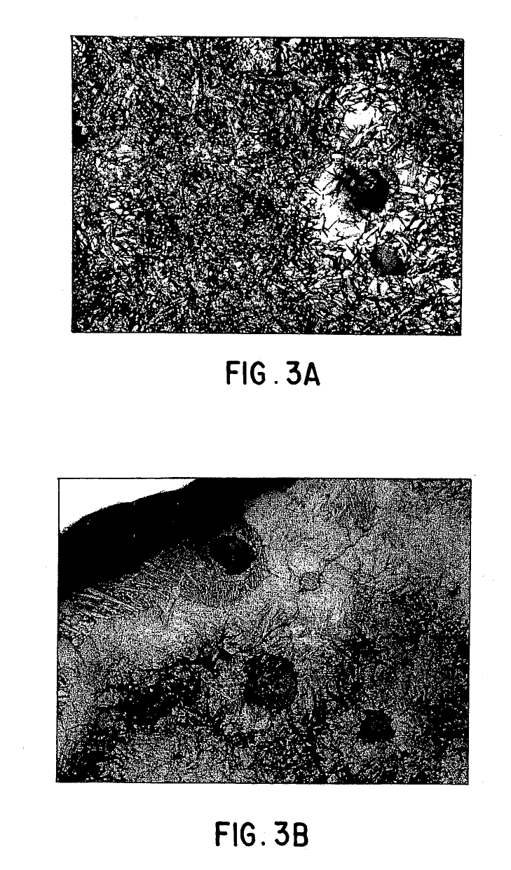

FIG. 3A is a microstructure of Sample ID #9 showing martenite at 1000× and 3% nital, which is a solution of nitric acid and alcohol. At this concentration, nital may be used as a chemical etchant for metallurgical evaluation of heat treated parts by allowing one to view the case depth of a heat-treated structure. By comparison, FIG. 3B is a microstructure of Sample ID #13 displaying the incipient melting zone and cracking associated with excessive laser power.

Although the invention has been described and illustrated in detail, it is to be clearly understood that the same is by way of illustration and example, and is not to be taken by way of limitation. The spirit and scope of the present invention are to be limited only by the terms of the appended claims.

What is claimed is:

1. A process for manufacturing a crankshaft having a fillet, comprising:
casting the crankshaft;
providing a laser;
rotating the crankshaft; and
irradiating the fillet using the laser.

2. The process of claim 1, wherein the fillet is rotated using center spindles.

3. The process of claim 1, further comprising using the crankshaft to quench heat created by irradiating the fillet.

4. The process of claim 1, wherein the crankshaft is used in the manufacture of an engine without mechanical rolling.

5. The process of claim 1, wherein the fillet is rotated 360° during the irradiating.

6. The process of claim 5, wherein the fillet is rotated more than 360° during the irradiating.

7. The process of claim 1, wherein the fillet has a surface, and the surface of the fillet is not melted during the irradiating.

8. The process of claim 1, wherein the fillet has a surface, and the surface of the fillet is treated to a depth of from about 0.5 mm to about 0.7 mm during the irradiating.

9. The process of claim 1, wherein the fillet has a surface, and the surface of the fillet is treated to a depth of from about 0.55 mm to about 0.65 mm during the irradiating.

10. The process of claim 1, wherein the fillet has a surface, and the surface of the fillet is treated to a depth of about 0.6 mm during the irradiating.

11. The process of claim 1, further comprising:
sensing the temperature of the fillet; and
controlling the speed of the rotating based upon the sensing.

12. The process of claim 1, further comprising:
sensing the temperature of the fillet; and
controlling the output of the irradiating based upon the sensing.

13. The process of claim 11, wherein an optical pyrometer is provided for the sensing.

14. The process of claim 12, wherein an optical pyrometer is provided for the sensing.

15. The process of claim 1, further comprising moving the laser to maintain a fixed distance between the laser and the fillet.

16. The process of claim 15, further comprising providing a controllable base to support and to move the laser.

17. The process of claim 15, further comprising providing an articulating robot to support and to move the laser.

18. An apparatus for manufacturing a crankshaft having a fillet, comprising:
a laser; and
a motorized rotary table;
wherein the fillet is irradiated and rotated.

19. The apparatus of claim 18, further comprising center spindles for holding and rotating the fillet.

20. The apparatus of claim 18, wherein the laser and rotary table are controlled such that the surface of the fillet is heat-treated to a depth of from about 0.5 mm to about 0.7 mm.

21. The apparatus of claim 18, wherein the laser and rotary table are controlled such that the surface of the fillet is heat-treated to a depth of from about 0.55 mm to about 0.65 mm.

22. The apparatus of claim 18, wherein the laser and rotary table are controlled such that the surface of the fillet is heat-treated to a depth of from about 0.6 mm.

23. The apparatus of claim 18, further comprising an optical pyrometer for sensing the temperature of the fillet.

24. The apparatus of claim 23, further comprising control circuitry for controlling the speed of the rotary table based upon a signal received from the optical pyrometer.

25. The apparatus of claim 23, further comprising control circuitry for controlling the output of the laser based upon a signal received from the optical pyrometer.

26. The apparatus of claim 18, further comprising a controllable base to support and to move the laser.

27. The apparatus of claim 18, further comprising an articulating robot to support and to move the laser.

28. A process for manufacturing a part, comprising:
casting a part;
irradiating the part to achieve a sufficient penetration depth to obtain compressive strength without melting the surface of the part.
